(19) United States
(12) Patent Application Publication
(10) Pub. No.: US 2008/0116607 A1
(43) Pub. Date: May 22, 2008

(54) Method and Apparatus for Manufacture of a Product from Composite Material

(76) Inventor: Andries Jan Miedema, Leeuwarden (NL)

Correspondence Address: HARNESS, DICKEY & PIERCE, P.L.C., P.O. BOX 8910, RESTON, VA, 20195, US

(21) Appl. No.: 11/578,508

(22) PCT Filed: Apr. 5, 2005
(86) PCT No.: PCT/NL05/00252

§ 371 Date: Aug. 10, 2007

(30) Foreign Application Priority Data
Apr. 16, 2004 (NL) 1025960

(51) Int. Cl. B29C 70/44

(52) U.S. Cl. 264/258; 425/405.2

(57) ABSTRACT

A method is disclosed for impregnating a layer of fibre material with a curable liquid so as to obtain a product of composite material, in particular an upright such as a lamppost or light mast or a post for a traffic light, a road sign, or for a direction sign. The method includes providing a mould, arranging a layer of the fibre material against a surface of the mould, arranging a covering layer over the fibre material in order to enclose the layer of fibre material between the mould and the covering layer, providing the curable liquid, and applying an underpressure to the space defined by the mould and the covering layer in order to enhance distribution of the liquid through the layer of fibre material wherein the mould is formed by a flexible element. The method further includes deploying the flexible element in a desired form.

The present invention relates to a method and an apparatus for impregnating a layer of fibre material with a curable liquid so as to obtain a product of composite material, in particular an upright such as a lamppost or a light mast, or a post for a traffic light or a post for a road sign, hollow transport conduits and so on.

Such a method and apparatus are generally known for forming products from composite material, such as windmill vanes, ship's hulls etc. The fibre material can here be impregnated in diverse ways with the curable liquid, more particularly a resin, wherein in all the cases known to the inventors use is made of a form-retaining mould part against which a layer of fibre material is arranged prior to impregnation thereof with the liquid.

The know techniques have a number of drawbacks. It is thus practically impossible to produce round, hollow or cylindrically hollow objects without first forming intermediate products which, when connected together, can form the whole, finally desired product. Two seams will be thus located for instance diametrically opposite each other along lampposts and flagpoles over the full length thereof where the semi-cylindrical intermediate products are fixed to each other in order to obtain the final product such as the lamppost or the flagpole.

It is noted that, in any case in terms of strength and collision-resistance in the case of lampposts as the products for manufacturing, this provides an insufficiently strong product. This is why manufacturers of products where the rigidity and strength of the products for manufacturing are very important factors have in the past always chosen to manufacture these products from steel, aluminium etc. Although flagpoles of composite material are known, the requirements in respect of for instance strength and collision-resistance are hardly a factor. A flagpole may moreover bend in the wind, which for a lamppost is wholly undesirable.

It is therefore the object of the invention to provide a method and an apparatus with which many new fields of application for composite material can be opened up, since products obtained with the method and the apparatus according to the invention display improved properties in all respects. The method and the apparatus for manufacturing such products from composite material are thus defined in the independent claims 1 and 12.

The objectives of the present invention are achieved with the method and apparatus.

The method according to the present invention has many preferred embodiments and specific features, which are defined in the dependent claims 2-11. With a method as according to claim 2 the final form of the product for manufacture is substantially defined by the combined action of the flexible element and the pressure body which brings the flexible element into the desired form. As a result of this combined action it is very readily possible to properly define a desired form of the final product. This takes place without making use of an expensive, form-retaining mould.

According to claim 3 such a pressure body is inflatable and the step of deploying the flexible element comprises of inflating the pressure body. While the element, which in fact forms the mould, is flexible it is as little stretchable as possible, so that inflating of the pressure body has the result that the shaping of the flexible element is still decisive in defining the form of the product to be finally manufactured.

Deploying of the flexible element can herein comprise of: providing the flexible element in a predetermined flat form and closing the flexible element around the pressure body while enclosing the layer of fibre material by connecting the selected sides or edges of the flexible element onto each other. In such an embodiment a wide diversity of designs of the product to be finally manufactured can be realized.

If for instance the flat form of the flexible element is that of a parallelepiped, a cylindrical or conical product such as a lamppost or a flagpole can be realized in simple manner with mutually connecting sides or edges of the flexible element which lie opposite each other. It can be advantageous here if the pressure body is a substantially or approximately cylindrical elongate bag. The elongate bag then defines the hollow space in the interior of the product to be finally manufactured.

It is further possible that connecting of the sides or edges of the flexible element comprises of: arranging clamping means along these sides or edges and closing the clamping means. The flexible element is thus closed around the pressure body while enclosing the layer of fibre material to enable this latter to be then impregnated.

Alternatively or additionally to the clamping means, other random closing means can also be arranged at sides or edges of the flexible element. These serve to close at the free edges or sides of the flexible element the space in which the layer of fibre material is received, so that an underpressure can be realized therein.

The clamping means can be connected via at least one coupling to a frame, wherein the method further comprises of disconnecting the coupling with the liquid in a still uncured state after the impregnation and removing the clamping means from the frame for further treatment, for instance a heat treatment, of the layer of liquid-impregnated fibre material in order to provide the product. The frame can thus be reused almost immediately after impregnation of the layer of fibre material when in a continuous process new couplings and clamping means and a new flexible element are brought into connection with the frame. The flexible element used immediately prior to this as mould for a preceding product is subjected in the deployed state to for instance a heat treatment to bring about curing of the curable liquid, for which purpose the frame does not remain “occupied” but is therefore immediately available for a subsequent production process.

Finally, it is noted that it is possible in the context of the present invention to arrange a location with a hatch or cover form between the flexible element and the layer of fibre material in order to define at least a contour of an access opening in the outer surface of the product. Such an access opening can, in the case of a lamppost, be a hole for closing with a cover through which access can be gained to the electrical cables in the interior of the lamppost. In the case of a flagpole such an access hatch can be used to operate lines or cables extending in the interior of the flagpole.

An apparatus according to the present invention has the means for performing at least the steps defined in the independent claim 1. Such an apparatus preferably also has means for implementing steps defined in the dependent claims 2-11.

The invention will be further elucidated hereinbelow on the basis of a preferred embodiment thereof, which is shown in the accompanying drawings but to which the present invention is not limited, wherein in the various drawings the same reference numerals are used for the same or similar parts and components, and in which:

FIG. 1 shows a side view of a lamppost as possible embodiment of a product as end product of a method according to the present invention produced with a corresponding apparatus;

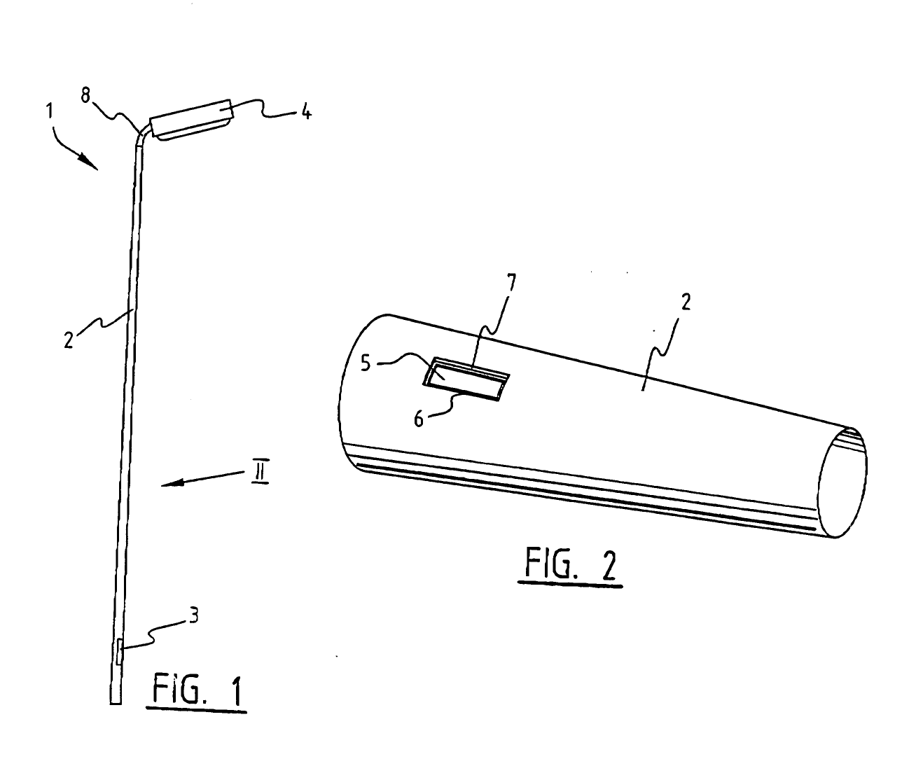

FIG. 2 is a perspective view of a section II of the lamppost shown in FIG. 1;

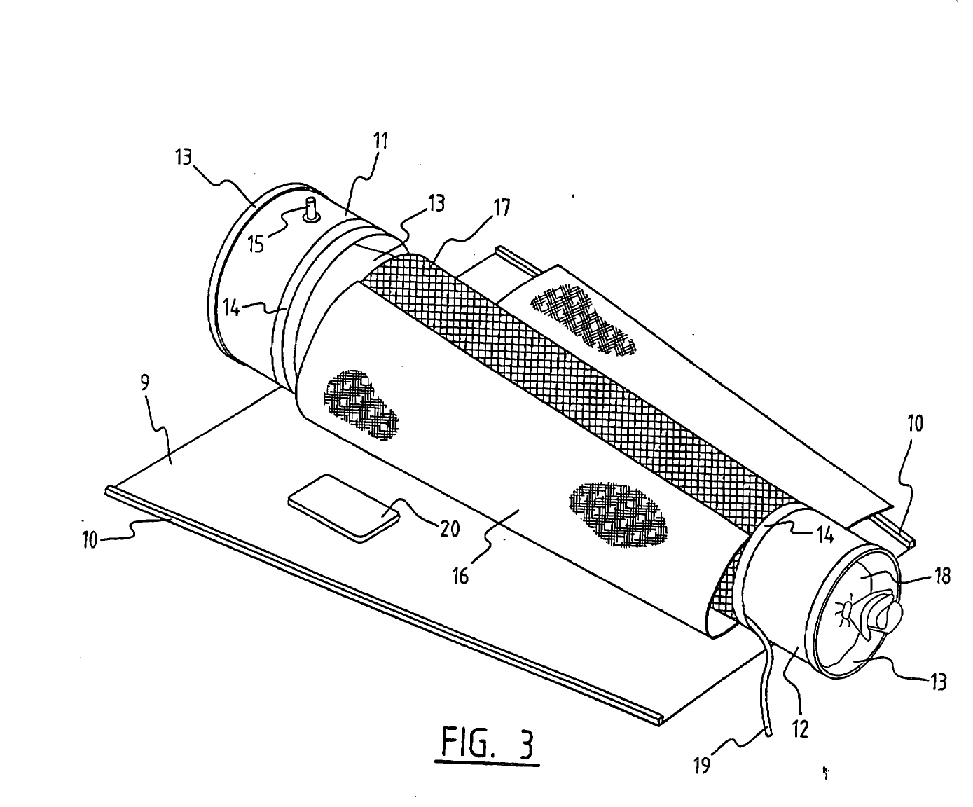

FIG. 3 is a view elucidating the method according to the present invention;

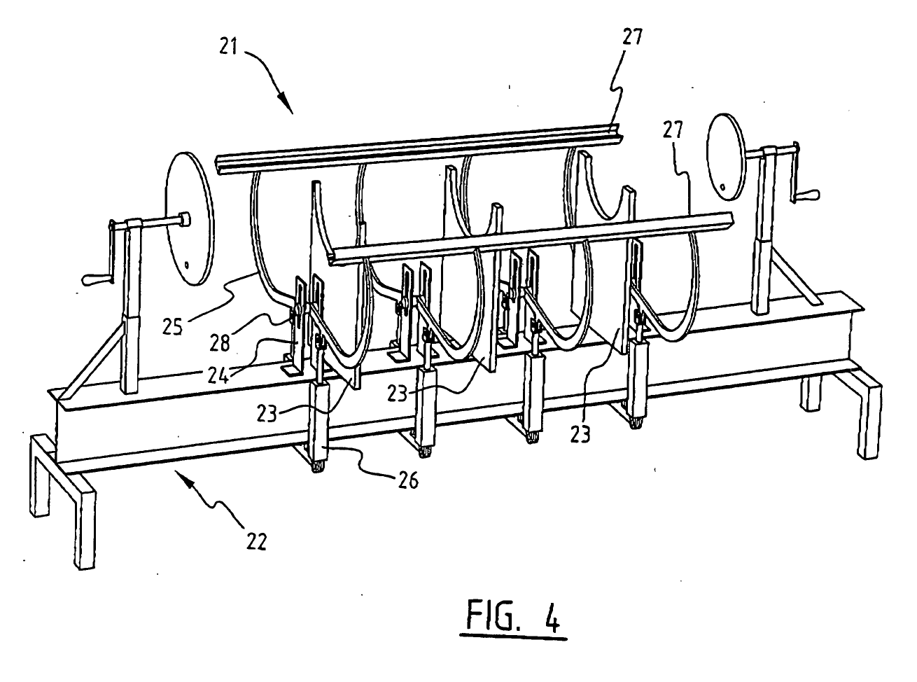

FIG. 4 shows a perspective view of an apparatus as possible embodiment of the present invention;

FIG. 5 shows the apparatus of FIG. 4 in operation;

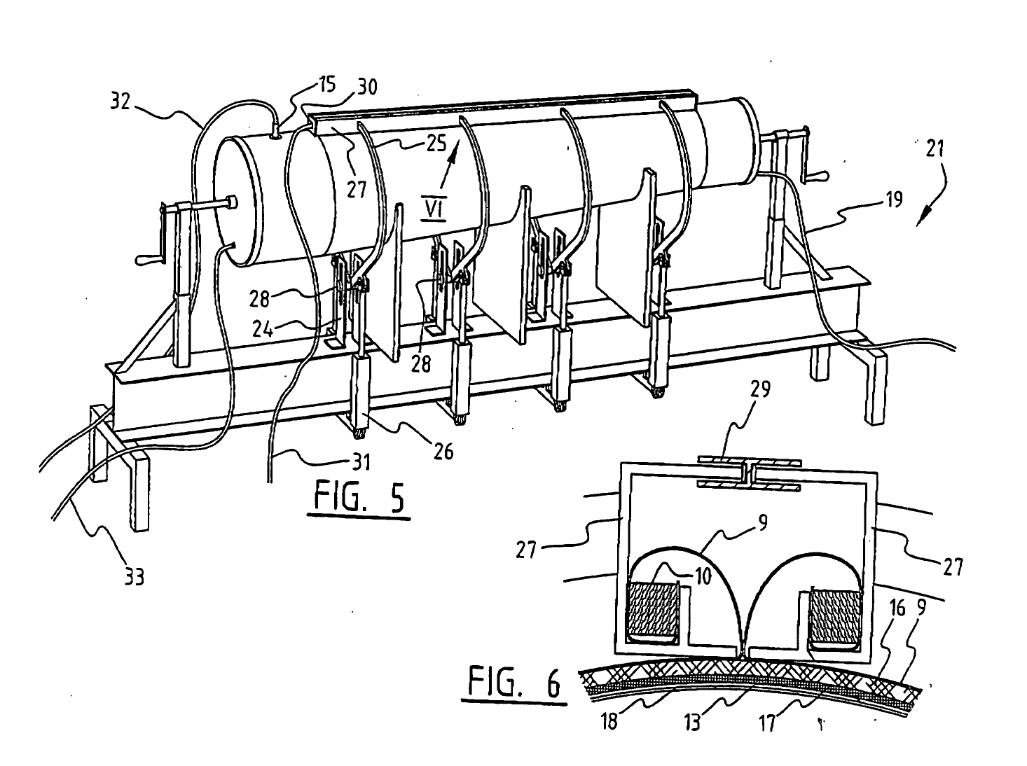

FIG. 6 shows a cross-sectional view of a detail designated with VI of clamping means of the apparatus of FIG. 5;

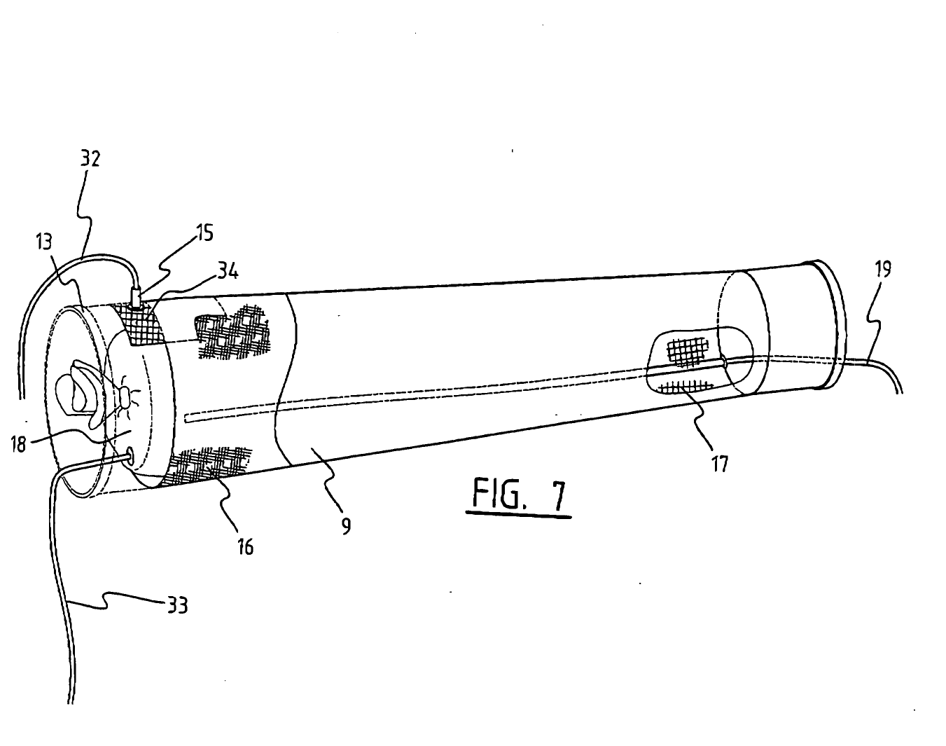

FIG. 7 is a perspective view of the basic operation of the present invention;

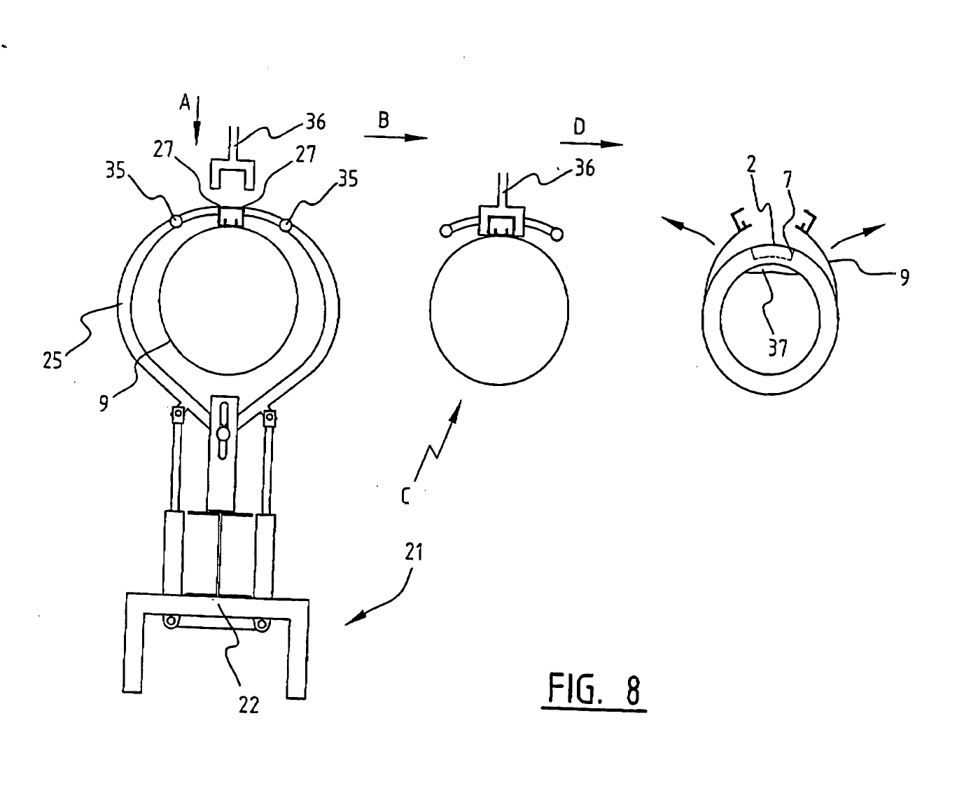

FIG. 8 shows schematically an automated production process; and

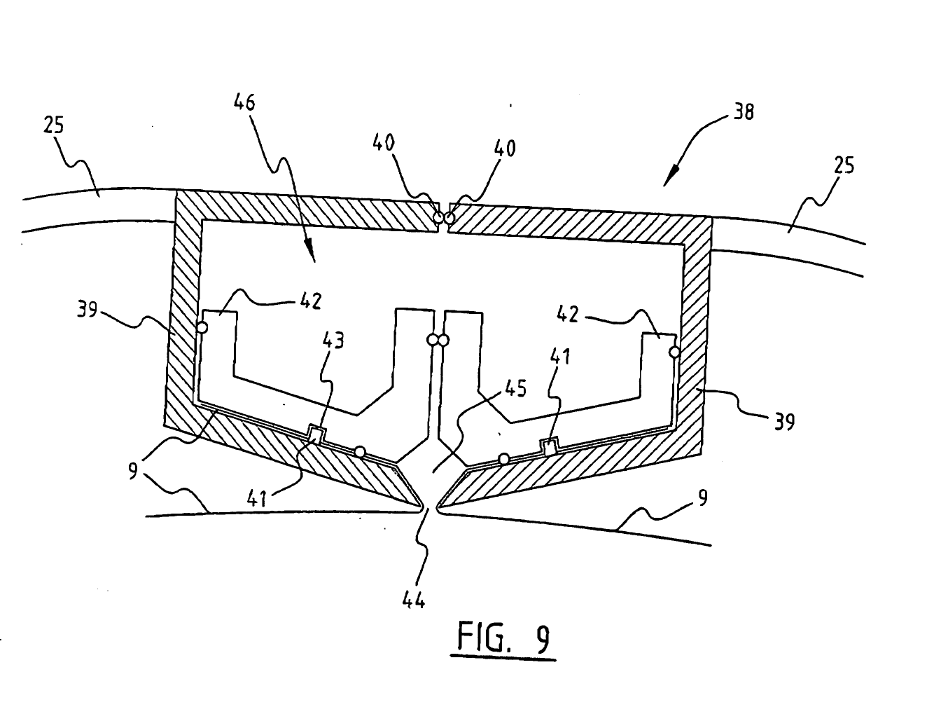

FIG. 9 shows an alternative of particularly the embodiment of FIG. 6 with engaging means therein.

The embodiment shown in FIG. 1 of a lamppost 1 of a product which can be obtained with a method and an apparatus according to the present invention comprises an upright 2 having therein an access opening closed by a cover 3, and further a lamp fixture 4. The upright 2 in particular can be obtained with a method and an apparatus according to the present invention. The upright 2 is shown in FIG. 2. It is clearly shown that the upright 2 of FIG. 2 has a cone shape, wherein it is noted that the view of FIG. 2 is greatly compressed in the length direction of upright 2. Cover 3 is further removed in the view of FIG. 2, which clearly shows that an access opening 5 lies behind cover 3. Access can be gained herethrough to wiring and the like located in upright 2. Access opening 5 is bounded by a flange 6 which connects to an edge 7 which in turn transposes into the outer surface of upright 2. Cover 3 of FIG. 1 comes to lie against flange 6, and edge 7 has a thickness corresponding to that of cover 3. A practically flat outer surface without protruding parts or sharp edges can thus be obtained at the position of such a cover 3.

In FIG. 1 a connecting piece 8 is used for the transition between upright 2 and lamp fixture 4. Lamp fixtures 4 and such connecting pieces 8 do not form specific subject-matter of the present invention which relates principally to the production of upright 2. Lamp fixture 4 and connecting piece 8 will therefore not be described further, the more so because they are constructions generally known in the art.

FIG. 3 shows schematically the production process for the upright shown in FIG. 2. A trapezoidal piece of foil 9, for instance of mylar, is used here. Mounting slats 10 are arranged on two opposite edges of foil 9. Arranged on the sides without mounting slat 10 are cylinders 11, 12 forming closing means, between which a sleeve-like foil layer 13 extends which is trained round the outer edges of cylinders 11, 12 and fixed at that position, for instance using double-sided adhesive tape. Such tape is also used to fix foil 9 later in the production process and is designated in FIG. 3 with reference numeral 14. When foil 9 is trained or rolled round cylinders 11, 12 it adheres to the double-sided adhesive tape 14 so that a space can be created between foil layer 13 and foil 9 with an underpressure or vacuum therein. Cylinder 11 comprises a connection 15 for connection thereto of a pump or the like to create an underpressure in this space between foil 9 and foil layer 13. In this space at least one layer of glass fibre material 16 is trained around foil layer 13 after a flow-enhancing gauze 17 per se known in the art has been arranged therearound. An inflatable bag as embodiment of a possible pressure body is preferably inflated to some extent prior to arranging the flow-enhancing gauze 17 and the layer of glass fibre material 16. The final form of upright 2 is thus obtained at least approximately, and the layers of the flow-enhancing gauze 17 and the layer of glass fibre material 16 can be arranged in convenient manner round foil layer 13. Foil 9 is then closed or trained therearound, wherein the edges of foil 9 without mounting slats 10 are thus engaged by double-sided adhesive tapes 14 and the edges of foil 9 with mounting slats 10 are connected to each other in the manner to be further described hereinbelow.

Further placed between the sleeve-like foil layer 13 and flow-enhancing gauze 17 is a hose 19 which at selected positions between tapes 14 comprises outflow openings for liquid for curing, in particular resin. Using flow-enhancing gauze 17 and as a result of the underpressure to be applied in the space between foil 9 and foil layer 13 such resin is well distributed through the layer of glass fibre material 16, this resin distribution taking place much more homogeneously and rapidly than if it were to take place manually using brushes. This is a per se known technique, for instance for vanes of windmills, wherein a form-retaining, rigid, hard mould was applied in this known art. Reference is made in this respect to the American U.S. Pat. No. 4,902,215, so that a further description of the mechanism of the resin distribution through the layer of glass fibre material 16 can be dispensed with.

It is further noted that a cover-like plate 20 is arranged between foil 9 and the layer of glass fibre material 16. Because the layer of foil 9 is flexible but not elastic, for which purpose a material such as mylar is for instance highly suitable, such a cover-like plate 20 leaves an impression in the layer of glass fibre material 16, this impression corresponding with edge 7 in FIG. 2. The glass fibre material of layer 16 is not interrupted at the position of the cover-like plate 20 so as not to impede the distribution of the resin at the position of cover-like plate 20. After completion of upright 2 the access opening 5 can then be arranged with a saw.

FIG. 4 shows an apparatus 21, or at least a portion thereof, for realizing at least the most essential steps of the method according to the invention as already substantially described above. Apparatus 21 comprises a frame 22. Shown as option thereon are partitions 23 which have an arcuate edge on the top in which the assembly, such as that of FIG. 3, can be placed. Further arranged on frame 22 are brackets 24 on which arms 25 are pivotally mounted, these being pivotable through the action of cylinders 26. There are two sets of arms 25, each supporting a closing profile 27, wherein closing profiles 27 form clamping means for joining together the sides of foil 9 in FIG. 3 on which mounting slats 10 are arranged. This is further shown in FIG. 6.

It is noted that the height of the pivot points 28 of arms 25 on brackets 24 is adjustable for the purpose of effecting and setting the conical form of upright 2 in FIG. 2 without measures or modifications to closing profiles 27. If the assembly of FIG. 3 is placed in the apparatus of FIG. 4, the arrangement is obtained as shown in FIG. 5. Use is made here between closing profiles 27 of an H-shaped sealing profile 29 and caps 30 are arranged on the ends of closing profiles 27 to also allow underpressure to be created in the space enclosed by closing profiles 27 using for instance a hose connected to a pump. Arranged on connection 15 is a similar hose 32 which can likewise be connected to a pump or the like to provide underpressure in the space between foil 9 and the sleeve-like foil layer 13. A hose 33 is further also provided for inflating bag 1S, an outer end of which is shown in FIG. 3.

The bag is also shown in the view of FIG. 7 which is substantially identical to the view of FIG. 5, but then without apparatus 21. Additionally shown herein is that an extra piece 34 of flow-enhancing gauze 17 is arranged at the position of connection 15 so that connection 15 is not closed by foil layer 13 and the suction via hose 32 and connection 15 affects all air in the space enclosed by foil layer 13 and foil 9 where the layer of glass fibre material 16 is situated. FIG. 7 also shows that hose 19 extends under flow-enhancing gauze 17 over practically the whole length of the upright 2 to be formed.

FIG. 8 shows schematically yet another embodiment of the method according to the present invention. Arranged here in arms 25 are coupling pieces 35 which can be disconnected. An engaging arm 36 can herein be lowered onto closing profiles 27 which are thus clamped against each other. The various hoses 31-33 and 19 are closed when impregnation is completed. Except for curing, there is now located in foil 9 a completed product which requires only curing of the curable liquid, for instance resin. Frame 22 of apparatus 21 does not however have to remain occupied for this purpose, and to this end couplings 35 are arranged. Before curing of the liquid, resin, the engaging arm 36 is therefore lowered onto closing profiles 27 which holds these profiles against each other. Engaging arm 36 can then be displaced laterally in the direction of arrow B, wherein the composite material still to be cured can be subjected to a treatment, for instance a heat treatment, which is indicated schematically with arrow C. In the meantime a new set of closing profiles 27 can be arranged on arms 25 of apparatus 21 by means of couplings 35, which are only represented schematically here in FIG. 8. Apparatus 21 can thus be used continuously without having to wait for curing of the product manufactured therein. Already manufactured products are transported in the direction of arrow D to an unpacking station where foil 9 is removed so as to expose the upright 2. At the position of cover-like plate 20 a recess is then created with edges 7 as also shown in FIG. 2. Only a hole need then be sawn in order to create closing opening 5 and to be left with flanges 6. A thickened portion 37 is formed as also shown in FIG. 8 at the position where the cover-like plate 20 has been placed.

FIG. 9 shows an alternative configuration relative to FIG. 6. Shown here is an alternative sealing system 38 where the H-shaped profile can be omitted and wherein a channel is simultaneously provided from the sealing profile for distribution of resin along the length of the light mast or lamppost being produced. The configuration 38 comprises closing profiles 39 which can be pressed against each other on the side remote from foil 9 with sealing means therebetween such as sealing strips 40, which can for instance take the form of cords of the same material as that from which O-rings are made. Foil 9 is herein provided with holes along the edge thereof, which holes have to be placed over pins 41, whereafter additional profiles 42 with recesses 43 can also be pressed onto pins 41, and closing profiles 39 are then pressed against each other. The additional profiles 42 also have sealing means or strips at various locations in order to effect a good sealing of the interior of the space enclosed by closing profiles 39 relative to the space in which is situated the glass fibre material that must be impregnated with the synthetic resin.

It is noted here that on the underside the closing profiles 39 do not fit fully against each other, i.e. on the side where the foil 9 runs out of the space formed by closing profiles 39. Here a passage 44 between closing profiles 39 is free for the flow of synthetic resin. Such an opening is for instance only 1 mm wide. Situated above this opening 44 is a channel 45 through which the synthetic resin can run or flow. At any random desired distance along the length of the light mast or upright to be formed synthetic resin can herein flow out of channel 45 through opening 44 in order to impregnate the glass fibre material located thereunder. A considerable simplification is thus provided compared to the previous embodiments, wherein an additional system is or was necessary in each case to bring about an adequate supply of synthetic resin.

It is further noted that a protective vacuum is deemed by the inventors to be necessary, or in any case desirable, in the space 46 formed by closing profiles 39, to the extent this space is closed off from channel 45 by the additional profiles 42.

The embodiment of FIG. 9 can also be used in reverse sense to that described above. It is possible herein to create an underpressure in channel 45 and thus draw air out of the fibre material through opening 44. Another feed for curable liquid must then be provided. This can be realized for instance by a hose or other conduit which extends between the mould and the covering layer on the side opposite configuration 38. Curable liquid coming out of the hose or conduit is then drawn to configuration 38 to thus impregnate the fibre material. Such a hose or conduit can comprise outflow openings along the length thereof for a uniform distribution of the curable liquid over the length of the product for manufacturing, in particular an upright. A hose or conduit ejecting the curable liquid on the distal end thereof can also be retracted gradually along the length of the product for manufacturing in order to introduce a sufficient quantity of curable liquid into the fibre material along the length so as to bring about, on the basis of the underpressure in channel 45, complete impregnation of all the fibre material between the hose or conduit and the configuration 38.

After perusal of the foregoing many additional and alternative embodiments will occur to the skilled person, all of which however form part of the present invention unless such additional and alternative embodiments depart from the essence of the appended claims, in particular the independent claims. It is thus possible for the inflatable bag in the interior of the assembly shown in FIG. 3 to be replaced by a conical tube or a solid element. The foil is described as flexible but can in addition display a predetermined degree of elasticity, although the flat form thereof is definitive in obtaining the final product. The degree of elasticity, to the extent known beforehand, can still result in readily reproducible products depending on the design and embodiment of the chosen means for deploying the flexible element etc. The field of application of the invention is also much wider than just lampposts and light masts. Posts for road signs or for traffic lights, direction signs and other uprights in general, and collision-safe uprights in traffic in particular, also fall within the invention. It is also possible to opt for a curable liquid which provides a transparent composite material. A light source or lamp can herein be arranged in the upright so as to increase the visibility of the upright with the light emitted therefrom.

1. Method for impregnating a layer of fibre material with a curable liquid so as to obtain a product of composite material, comprising:
providing a mould;
arranging a layer of the fibre material against a surface of the mould;
arranging a covering layer over the fibre material in order to enclose the layer of fibre material between the mould and the covering layer;
providing the curable liquid;
applying an underpressure to the space defined by the mould and the covering layer in order to enhance distribution of the liquid through the layer of fibre material,
wherein the mould is formed by a flexible element; and:
deploying the flexible element in a desired form by arranging a pressure body on the side located opposite the flexible element relative to the layer of fibre material, so as to deploy the flexible element in the desired form while clamping the layer of fibre material, wherein
deploying the flexible element in the desired form includes: providing the flexible element in a predetermined flat form; and closing the flexible element around the pressure body while enclosing the layer of fibre material by connecting selected sides or edges of the flexible element to each other.

2. Method as claimed in claim 1, wherein the pressure body is inflatable and the step of deploying the flexible element comprises of inflating the pressure body.

3. Method as claimed in claim 1, wherein the flat form of the flexible element is that of a parallelepiped.

4. Method as claimed in claim 3, comprising of mutually connecting two edges of the parallelepipedal flexible element which lie opposite each other, wherein the product is hollow and substantially conical or cylindrical, such as a lamppost.

5. Method as claimed in claim 2, wherein the pressure body is a substantially or approximately cylindrical elongate bag.

6. Method as claimed in claim 1, wherein connecting of the sides or edges of the flexible element comprises arranging engaging or clamping devices along these sides or edges, and energizing the engaging device or closing the clamping device.

7. Method as claimed in claim 1, further comprising or arranging closing devices at free sides or edges of the flexible element, at which free edges no engaging or clamping devices are arranged.

8. Method as claimed in claim 6, wherein the engaging or clamping devices are connected via at least one coupling to a frame, and wherein the method further comprises disconnecting the coupling with the liquid in a still uncured state after the impregnation and removing the clamping device from the frame for further treatment of the layer of fibre material impregnated with the liquid in order to provide the product.

9. Method as claimed in claim 1, further comprising placing a place with a hatch or cover form between the flexible element and the layer of fibre material in order to define at least a contour of an access opening in the outer surface of the product.

10. Apparatus for impregnating a layer of fibre material with a curable liquid so as to obtain a product of composite material comprising:
means for providing a mould;
means for arranging a layer of the fibre material against the surface of the mould;
means for arranging a covering layer over the fibre material in order to enclose the layer of fibre material between the mould and the covering layer;
means for providing the curable liquid;
means for applying an underpressure to the space defined by the mould and the covering layer in order to enhance distribution of the liquid through the layer of fibre material,
wherein the mould is formed by a flexible element; and
means for deploying the flexible element in a desired form by arranging a pressure body on the side located opposite the flexible element relative to the layer of fibre material, so as to deploy the flexible element in the desired form while clamping the layer of fibre material, wherein deploying the flexible element in the desired form includes: providing the flexible element in a predetermined flat form; and closing the flexible element around the pressure body while enclosing the layer of fibre material by connecting selected sides or edges of the flexible element to each other.

11. Product to be obtained with or by a method as claimed in claim 1, where the product includes at least one of an upright, a lamppost, a light mast, a post for a traffic light, a post for a road sign and a post for a direction sign.

12. (canceled)

13. Method as claimed in claim 4, wherein the pressure body is a substantially or approximately cylindrical elongate bag.

14. Method as claimed in claim 7, wherein the engaging or clamping devices are connected via at least one coupling to a frame, and wherein the method further comprises of: disconnecting the coupling with the liquid in a still uncured state after the impregnation and removing the clamping device from the frame for further treatment of the layer of fibre material impregnated with the liquid in order to provide the product.
